(19) United States
(12) Patent Application Publication
(10) Pub. No.: US 2005/0132207 A1
(43) Pub. Date: Jun. 16, 2005

(54) System and method for authoring learning material using digital ownership rights

(76) Inventor: Magda Mourad, Yorktown Heights, NY (US)

Correspondence Address: McGuireWoods, LLP;Tysons Corner, 1750 Tysons Boulevard, Suite 1800, McLean, VA, 22102-3915, US

(21) Appl. No.: 10/731,020

(22) Filed: Dec. 10, 2003

(51) Int. Cl. H04L 9/32

(52) U.S. Cl. 713/189

(57) ABSTRACT

A system and method for authors of on-line learning material and learning objects is provided to develop and store their learning objects while also protecting their digital rights during the marketing and distribution of the learning objects. The digital content may include such asset content as video, music, text, educational content, or the like. Various stages of the invention include: (i) author registration that permits authors to access and become a registered user of the system, (ii) author content creation that permits authors to compose and create a Shareable Content Object (SCO) which represents one or more assets, (iii) DRM packaging that permits name tagging and security encasement, and (iv) ingesting and eStore publishing.

### BACKGROUND OF THE INVENTION

1. Field of the Invention

The invention generally relates to a system and method of providing digital rights management for objects, and more particularly, to providing authors of digital content to create and distribute the digital content using a uniform process.

2. Background Description

Advances in electronic commerce, such as the Internet, now permit distribution of valuable digital content rapidly and immediately over various networks. Electronic commerce permits digital content to be downloaded to client systems in many different formats, however, security for enforcing and controlling ownership rights to the digital contents continues to be problematic while allowing the authors of the digital content flexibility and convenience in creating, marketing and distributing the content.

Creators and authors of digital content typically do not wish to be burdened with the overhead and demands of packaging and protecting their digital electronic content, but would rather concern themselves mostly with the content, itself, and perhaps marketing issues. Currently, packaging the electronic content and overseeing the distribution of the electronic content is burdensome, something authors would rather defer or avoid entirely.

A number of Digital Rights Management (DRM) products have attempted to address certain issues of licensing and controlling distribution of digital contents. One concern is to prevent unauthorized duplication of digital content after it has been download to a client system. A solution has been to encrypt the electronic content, and associate rights to such content. In such as system, after acquiring the rights to access the content, a user may only then access and decrypt the contents. In fact, some DRM systems prevent users from directly decrypting the contents. Therefore, they cannot decrypt the contents, save them, and distribute them in decrypted form, unless permitted to do so by authorized DRM software.

A generally adopted approach to DRM management has been to provide a specific player (new browser or media player, etc.) which users must install and use for accessing DRM content. However, this approach is not very flexible and too restrictive for accessing generally distributed digital content by large numbers of authors, such as, for example, individual college faculty members to commercial publishers, etc.

An issue not addressed though by DRM, is when authors of electronic content wish to provide multiple related digital contents as parts (e.g., video, text, music, and educational content) and control the individual parts from creation through distribution. Existing DRM mechanisms that are currently available for creating and managing the control of the multiple parts is inadequate and provide no relief from the complex burdens of creating, packaging and on-going distribution control. This, of course, is very burdensome and time consuming.

Also, currently, there is no comprehensive system or service that can provide overall management and creation process by authors. Issues such as creation control, secure evolutionary protection, rights management, storage, standards compliance are not being addressed so that these issues are kept to a minimal concern.

### SUMMARY OF THE INVENTION

In an aspect of the invention, there is a method for providing learning objects. The method comprises accessing an authoring application for creating a shareable content object (SCO) through a web based remote access and/or via download of the authoring application. Further the invention provides for composing a shareable content object (SCO) representing one or more assets, assigning a digital rights to the SCO to secure the one or more assets, and individually controlling access to the SCO and the one or more assets by utilizing the assigned digital rights to the SCO or the one or more assets.

In another aspect of the invention, a method for creating learning objects is provided. The method comprises creating a package containing one or more shareable content objects (SCOs), assigning digital rights management (DRM) to the one or more SCOs, updating an on-line electronic store (e-Store) with the one or more SCOs, and making the one or more SCOs available for searching and downloading at a client, wherein access to the one or more SCOs is controlled by the DRM, and the one or more SCOs include one or more assets.

In another aspect of the invention, there is a system for providing learning objects. The system comprises a portal server to permit authoring of at least one shareable content object (SCO) having one or more assets, a digital rights management (DRM) content packager accessible via the portal server for assigning digital rights to the at least one shareable content object (SCO), a DRM license server for assigning license criteria to the at least one SCO and the one or more assets and a content manager for storing or retrieving the at least one SCO and the one or more assets.

In another aspect of the invention, a digital rights protection system is provided that includes a secure uploading service capable of receiving unprotected digital content having one or more parts, associated metadata, and any promotional materials. The invention also includes an automatic validation component adapted to ensure conformance of the unprotected digital content to Shareable Content Object Reference Model (SCORM) standards and providing error messages to enable correction, and a digital rights generation layer having one or more components adapted to provide a web-based interface for specifying different rights to the one or more parts for providing protected digital content.

In another aspect of the invention, a computer program product is provided comprising a computer usable medium having readable program code embodied in the medium and includes the computer program product includes a first computer to compose a shareable content object (SCO) representing one or more assets, a second computer code to assign a digital rights to the SCO to secure the one or more assets, and a third computer code access the SCO and the one or more assets, wherein the access to the SCO and the one or more assets is controlled by the assigned digital rights.

### BRIEF DESCRIPTION OF THE DRAWINGS

FIG. 1 is a block diagram of an embodiment of the invention;

FIG. 2 is a flow chart of steps of an embodiment for using the invention;

FIG. 3 a flow chart showing steps of an embodiment of DRM packaging; and

FIG. 4 is a flow chart showing steps of an embodiment of modifying and updating an eStore.

### DETAILED DESCRIPTION OF EMBODIMENTS OF THE INVENTION

This invention provides a system and method for authors of on-line material (e.g., learning objects) to develop and store their learning objects while also protecting their digital rights during the marketing and distribution of such learning objects. The digital content may include such asset content as video, music, text, educational content, or the like.

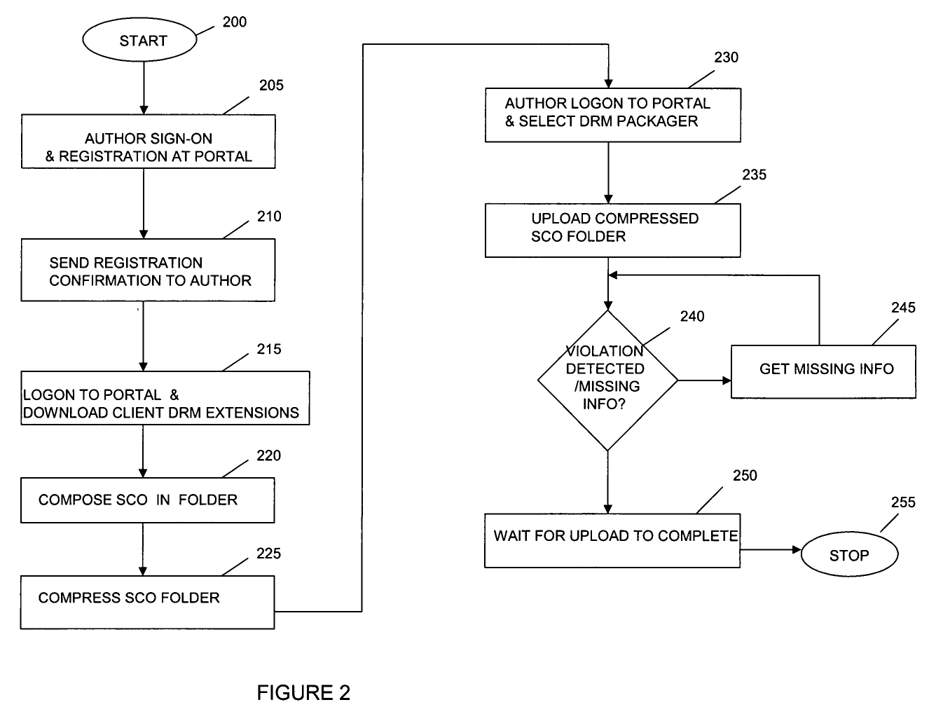

The method and system of the invention may provide for various stages/layers that include, for example: (i) author registration that permits authors to access and become a registered user of the system; (ii) author content creation that permits authors to compose and create a Shareable Content Object (SCO) which represents one or more assets; (iii) DRM packaging that permits name tagging and security encasement, and (iv) ingesting and eStore publishing. These stages are described below in reference to FIGS. 2-4.

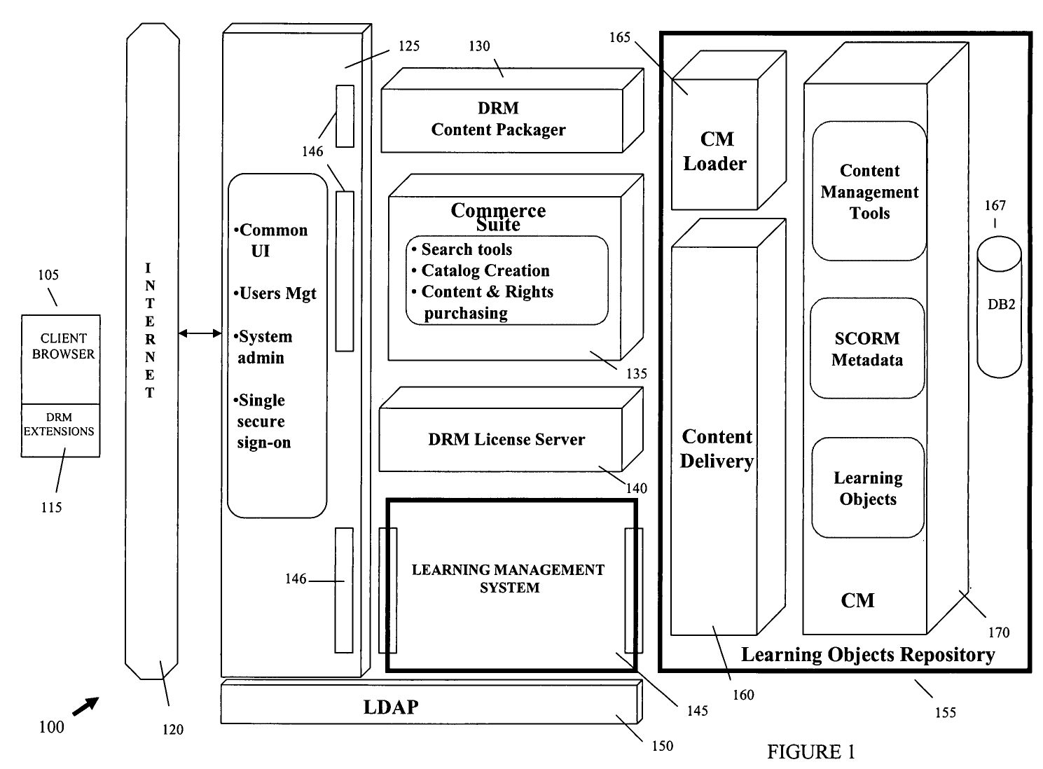

FIG. 1 is a block diagram of an embodiment of the invention, generally denoted by reference numeral 100. The invention includes one or more client systems 105 (e.g., a personal computer (PC)) having a browser and DRM extensions 115, for managing digital rights at the client. The client systems 105 communicate via a network, such as the Internet 120, to one or more servers that include a portal server 125 ( e.g. IBM's Websphere™, or the like) that has one or more universal resource locators (URLs) and/or uniform resource identifiers (URI) for allowing single secure sign-on by users with a common user interface. The portal server 125 may also have the capability of provisioning a system administration function and user management. The system administration function encompasses handling the creation of different user's accounts with different roles and associates each user according to his role to a specific commerce suite 135 (e.g. Websphere Commerce Suite) for providing suppliers and account managers with commerce functionality, such as, for example, (i) contract view and update/approval, (ii) order management business processes, (iii) request for quote (RFQ) creation and approval, and, (iv) invoicing view and update, etc. The commerce suite 135 may include an electronic store (eStore) for receiving, storing, searching and cataloging digital content, and for making the digital content available for distribution.

The system of FIG. 1 further includes a DRM content packager 130 for receiving new digital content from an author and securely packaging the content. Also included may be an electronic store (eStore) 135 for receiving, storing, searching and cataloging digital content, and for making the digital content available for distribution. The system further includes a DRM license server 140 to generate a key pair for a client and maintain the client public key for future encryption purposes and sends a private key to a client, when appropriate. All components associated with rights generation typically have a public-key certificate by a certificate authority that all the components are trusted.

The invention further includes a learning management sub-system (LMS) 145 (for example, Lotus Learning Management System) which provides a learning environment that delivers and manages a classroom-based, e-learning centric, operation using digital contents maintained in a learning objects repository 155. The LMS 145 may be used to provide corporate or university training solutions (or the like) or other digital information using the DRM protection capabilities of the invention. A lightweight directory access protocol (LDAP) may be employed for authenticating users signing onto the portlets 146 of the portal server 125.

The system further includes a learning objects repository (LOR) 155 which is a long term storage and management portion that receives and delivers packaged digital content and other data. The LOR 155 includes a content delivery 160 capability for accessing and providing digital content (as requested by the LMS and other portions of the system), and a content management loader 165 for handling requests from the DRM content packager 130 to package updates, versioning, insertions, or deletions into/from a content manager 170. The content manager 170 manages the learning objects, Shareable Content Object Reference Model (SCORM) metadata (SCORM is a generally known standard initiative), and content management tools, themselves, for operational manipulation of all the digital content and learning objects. A database 167 may also be used to store the learning objects. The SCORM metadata typically comprises one or more files generated by an author to describe the digital contents or the learning objects for searching by users or subscribers.

FIGS. 2-4 are flow diagrams of an embodiment showing steps of using the invention. FIGS. 2-4 may equally represent a high-level block diagram of components of the invention implementing the steps thereof. The steps of FIGS. 2-4 may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. FIGS. 2-4 may be implemented, for example, using the components of FIG. 1.

FIG. 2 is a flow chart of an embodiment of steps for using the invention starting at step 200. At step 205 an author, using a client system, signs on with the portal server. This may include, for example, starting an Internet Explorer (IE) session (or similar session) and going to the URL of the portal server (e.g. http:// . . . ). The user may click on a “Signup” link presented by the portal server (e.g., Websphere), fill in a Web form with the author's personal information, and submit the information. At step 210, the system sends back an email (or other notification) containing the author's registration confirmation, a user-id, a password (pw), and a logon URL, or other desired information.

At step 215, the author navigates to the logon URL of the portal server (e.g., http:// . . . ) as previously supplied, and accesses the system registration link and supplies the author's user-id and pw to register. The logon URL provides authors with web pages that are presented through the eLearning Portal for rendering portlets (e.g., 146) for the different components (e.g., LMS, eStore, and DRM packager, etc.) of the system into one common interface that is personalized according to the user's profile and role. The portal server also provides a single sign-on to those portlets, authenticating the users through LDAP or similar authentication process.

When the author uses the user id and pw to logon to the system for a first time, registration and downloading of any extensions (software) needed to allow the author's browser to render DRM protected content occurs, this process may include the following operations:
i) Checking the browser's version and downloading the extension code for DRM enablement appropriate for the version.
ii) Downloading the application that the author will use to create the extended SCO rights metadata that is compliant to Open Digital Rights (ODRL) format (or any other generally known Digital rights expression Language) and the promo material.
iii) The DRM license server generates the key pair for the client and maintains the client public key for future encryption purposes and sends the private key to the client.

Also, at step 215, a file download window appears and the user may logon and optionally select to download an authoring application tool for SCO creation or download a DRM extension to the user's client system. Authoring may alternatively occur as a remote web-based access. At step 220, a SCO is composed by an author and placed in a folder. This may be accomplished by using the downloaded authoring application tool which may be a SCORM compliant authoring tool to compose a shareable content object (SCO) on the client system (e.g., a personal computer). The SCORM tool may be a part of the DRM extensions 115. The SCO includes representation of a collection of one or more assets with their standard-compliant metadata and content packaging files. The author uses a SCORM compliant authoring tool to compose a Sharable Content Object (SCO), which represents a collection of one or more assets that include a specific launchable asset utilizing the SCORM run-time environment to communicate with learning management software (e.g., 145).

The SCO, in one aspect, represents the lowest level of granularity of learning resources that typically can be tracked by the LMS using the SCORM run-time environment. The SCO may contain assets that are electronic representations of media, text, images, sound, web pages, assessment objects or other pieces of data that can be delivered to a Web client. An asset and SCO may be described with asset and SCO meta-data to allow for search and discovery within online repositories, thereby enhancing opportunities for reuse. The mechanism for binding assets and SCOs to asset and SCOs meta-data is provided by a standard content packaging information model. The SCORM meta-data information model describes data elements that are defined to build SCORM conformant meta-data records and may include additional data elements. All elements labeled as container elements allow for the capability to add extensions. Since the “rights” element may be labeled as a container element, then it may be extended to add a new element “drm”, for applying digital rights. The “drm” element may be used to reference the rights file that contains the usage rights of the SCORM learning asset (e.g., asset, SCO, content aggregation) which may be a local, or remote (e.g.,URL).

Learning content in its most basic form is typically composed of assets that are electronic representations of media, text, images, sound, Web pages, assessment objects, or other pieces of data that may be delivered to a Web client. A SCO may be a collection of one or more assets that utilizes SCORM run-time environment to communicate with LMSs. A SCO represents the lowest level of content granularity that is tracked by an LMS using SCORM run-time environment. A SCORM resource package application profile defines a mechanism for packaging learning resources (e.g., assets and SCOs) without having to provide a specific organization, learning context, or curricular taxonomy. Packaging learning resources provides a common medium of exchange. A SCORM content package is typically a collection of reusable learning resources that may be transferred between learning systems. SCORM conformant meta-data records contain information that makes these assets/learning resources independent, searchable, and re-usable.

In many cases, an asset or SCO may be a single file. However, there are cases where assets and SCOs may include multiple files. The SCORM resource package application profile allows for packaging assets and SCOs that comprise single files or multiple files. Also, assets and SCOs may be included locally or may be referenced externally. Locally packaged files may be included as physical files, and when referenced externally, the assets and SCOs may not be included it package, but instead via an URL.

Still referring to FIG. 2, at step 225, the SCO common folder is compressed (using a ZIP utility or the like) to produce a package.zip file. At step 230, a DRM packaging session is started on the client system and the author logons to a portal and selects a DRM packager.

At step 235, the SCO compressed package (e.g., package.zip) is uploaded using a DRM packager portlet link when presented to the author. To aid the author, a Web page may be displayed for the author to input the path of the authored directories and to select the package.zip file path that is used for the zip file name field during uploading. An upload confirmation message may be displayed in the browser to indicate upload complete.

At step 240, a check is made whether any information is missing or a violation has occurred and, if so, at step 245, an inquiry is presented to the author for missing information. If there is no missing information or violation, then at step 250, the process waits for the upload to complete, and the process completes at step 255.

When the author is provided with a desktop application, it may be an applet based web-application to run on the client system. The applet may define:
i) The rights that is associated with each individual SCO asset of an SCO. This application creates a “rights file” (that is compliant with ODRL language) and extends the SCO Rights Metadata to include this ODRL “rights file” (which may be an extensible markup language (XML) based file). Alternatively, a generally known format, for example, moving pictures expert group (MPEG) rights expression language (MPEG REL, a generally known expression language) may be employed. The rights may include defining at least one of price, identity of the user, and length of use of each asset. ODRL is an XML rights expression language based on a model that establishes relationships among assets, parties, and rights. Assets may be digital objects identified by a globally unique identifier. Parties may be rights holders such as, for example, people or organizations, referred to as rights holders. Rights include permissions, requirements, and conditions.
ii) Any promotional material and a thumbnail to be used as a promotional material in a catalog on the eStore. A promo.xml file may be created with the corresponding thumbnail in a promo folder under the root folder of the package.

The generated digital content files may be placed under a SCO common folder. The author may use the desktop application that was downloaded during the registration process for this purpose. This desktop application may be an applet-based web-application running on the author's machine and may also provide the author with interfaces to:
i) Create the extended SCO Rights Metadata, which is compliant to the ODRL format and is to be associated with its Metadata file.
ii) Prepare any promotional materials, including a thumbnail presentation of the SCO in a promo folder under the SCO common folder.

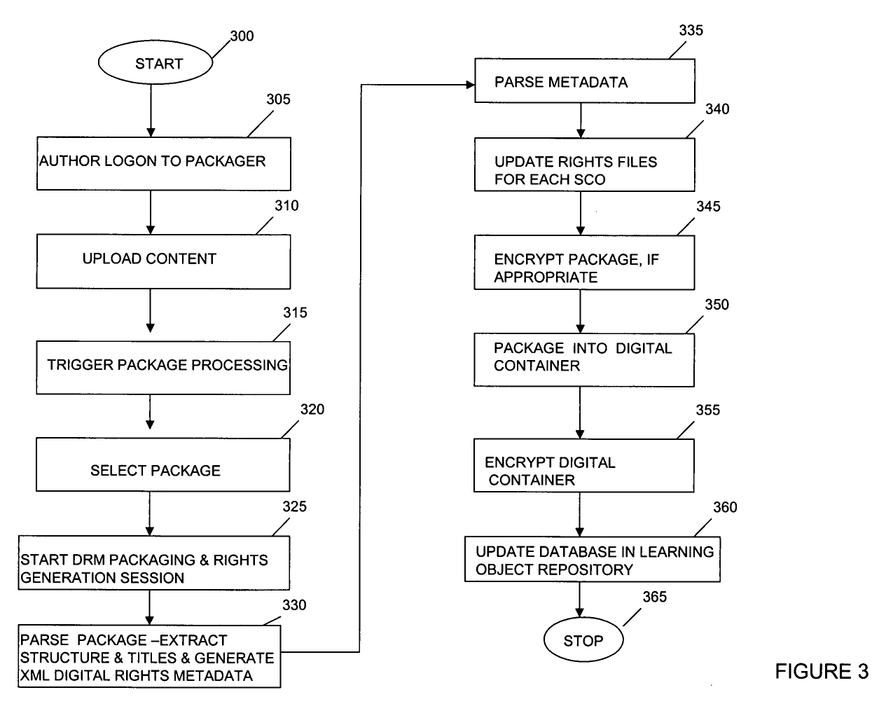

FIG. 3 is a flow chart showing steps of an embodiment of DRM packaging, starting at step 300. These steps of FIG. 3 may also be employed, for example, by steps 230 and 235 of FIG. 2. At step 305, the author logs onto the remote J2EE (Java 2 platform, Enterprise Edition) packager (i.e., DRM packer) and, at step 310, uploads the content package (package.zip) into the DRM content packager incoming folder using HTTPS (hypertext transfer protocol) connection (or the like).

At 315, the user triggers the DRM content packager to process the uploaded package file (including the SCO and promotional material). At step 320, the user may browse and select the package filename into the DRM content packager web page and then invokes the DRM content packager to process this file. At step 325, a DRM packaging and rights generation session is started.

At step 330, the DRM content packager parses the package file to extract the structure and titles of the packaged SCO and generates digital rights metadata files accordingly. Consequently, each entire SCO is treated as a package and given a universally unique PackageID with a PkgName generated from the folder name on which each SCO is stored and a UID to assure its uniqueness in this packager.

The extracted promo.xml may also be updated with the following:
i) The SCO PackageID;
ii) Whether the SCO (and assets) is encrypted or not;
iii) Whether the SCO is to be delivered to the user in an online mode through LMS or offline by downloading it on the user's machines;
iv) The type of package (Course/SCO);
v) License Server address;
vi) The content manager address; and
vii) The promo contents (e.g., promo.xml and thumbnails) are packaged into a secure container “Promo Secure Container”.

At step 335, the metadata of each SCO is parsed to identify whether this SCO should be DRM protected or not and whether it should be taken online through an LMS or offline (disconnected mode) through the client's machine. At step 340, the rights file associated with each SCO is updated. At step 345, the assets of each package (SCO) may be encrypted independently using randomly generated symmetric keys of each package (SCO) (only if the package is marked for encryption) or assigned individual rights. Packages may be assigned rights from the web-based interface provided to the authors to use for assigning rights that they associate with their content. This may be automatically translated by the system into rights fields' extensions in the associated metadata DR fields and appropriate rights files may also be automatically generated. The rights file of each SCO may be updated with symmetric keys used for its encryption (only if the package is marked for encryption) and the symmetric keys may be stored in associated metadata file, then encrypted with the DRM license server provided public key. Typically, the author (or other owner) owns the license rights to each SCO which facilitates pricing structure according to the author's (or other owner) desire which are enforced by the rights file of each SCO.

At step 350, the encrypted package (SCO) is packaged into a secure container “Content Secure Container” and each given a universally unique name PackageID-Content. The content aggregation files (e.g. ContentAggregation “CA” files=MetaData “MD”+Manifest “MF”+Content Packaging Info “CP+encrypted Rights “R”) of each SCO are placed into the secure container, “Content Aggregation Secure Container,” each with a universally unique name PackageID-CA. The assets and SCO content are packaged separately from the CA files in order to avoid uploading the assets each time the rights or offers are updated. At step 355, At step 355, the digital container may be encrypted.

The file transfer between components using Web services (i.e., applications components whose functionality and interfaces are exposed to users through application of Web technology, e.g., XML, HTTP, SOAP, etc.) may be accomplished by creating a Java object that stores the file to be transferred and this Java object is passed as a parameter through Web services. The DRM content packager invokes the CM loader to ingest the SCO package.

At step 360, the DRM content packager invokes a Web service to update a database (e.g., 167) in the learning object repository, passing it the Promo package for package updates or inserting a new package. Also, the store is notified in the same Web service whether an UPDATE, INSERT or DELETE operation is to be performed on this package identified with PackagelD. This repository component prevents any input/output operation that may lead to a rights violation when protected digital contents are stored. In embodiments, the DRM content packager is typically the component that has the authority to update or delete contents from the system, as it is the component that owns the assets before being purchased. The process completes at step 365.

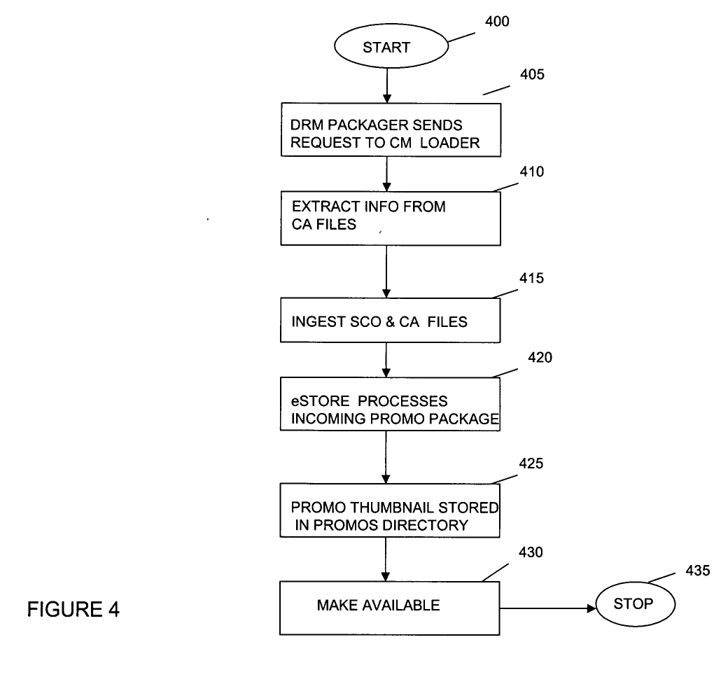

FIG. 4 is a flow diagram showing steps of an embodiment of modifying and updating the eStore, beginning at step 400. At step 405, the CM loader's request handler (part of the CM Loader) handles a request from the DRM content packager for any package requiring UPDATE, INSERT or DELETE. The request handler typically maintains the session connection between the DRM packager and the CM loader at step 410, after recovering a SCO file, the request handler may invoke a file container processor to process those files for extracting the necessary information from the CA files. At step 415, the SCO content and CA files are ingested into a CM resource manager as an item of two parts whose attributes are the information extracted from the CA files (which is typically from the SCORM metadata XML files).

At step 420, the eStore processes the incoming promo package to extract the promo.xml (if it exists) to update the catalog information in the eStore database. At step 425, the eStore Web service checks for which operation is to be performed at the store (i.e., whether UPDATE, DELETE or INSERT). If the operation is an INSERT operation the promo.xml is used directly to add a new entry in the eStore catalog database. If it is an UPDATE operation, the promo.xml may be used to update the entry in the eStore catalog database. If it is a DELETE operation there will be no promo.xml and only the PackageID is used to delete the appropriate record from the eStore database. At step 425, the promo thumbnail is stored in the eStore's promos directory. At step 430, the digital contents are made available to users.

Thus, the invention provides for authors of on-line learning material (e.g.,learning objects) to develop and centrally store their learning objects while also protecting their digital rights throughout the life-cycle of a product. The digital content may include one or more asset content such as video, music, text, educational content, or the like, and each asset may individually be assigned digital rights to control access.

Each SCO and rights may also provide a mechanism to associate different pricing structures for different components, according to the components, or charge differently based upon the client/customer identity or role. For example, an individual is charged differently than a corporation or a faculty member.

When a user (e.g., a student) accesses a SCO via the LMS or offline, the rights of the accessed SCO and each asset associated with the SCO may now be individually enforced in the browser at the client system (e.g., personal computer) using the digital container rights associated with each SCO. Additionally, each SCO and each asset associated with the SCO in a digital container may each bear a unique price, enforced by the digital rights container.

While the invention has been described in terms of embodiments, those skilled in the art will recognize that the invention can be practiced with modifications and in the spirit and scope of the appended claims.

1. A method of providing learning objects, comprising:
accessing an authoring application for creating a shareable content object (SCO), the accessing being through at least one of a web based remote access and a download of the authoring application;
composing a shareable content object (SCO) representing one or more assets using the authoring application;
assigning a digital rights to the SCO to secure the one or more assets; and
individually controlling access to the SCO and the one or more assets by utilizing the assigned digital rights to the SCO or the one or more assets.

2. The method of claim 1, wherein the accessing an authoring application step includes:
accessing an on-line portal server to obtain registration information; and
registering as an author of learning objects.

3. The method of claim 2, wherein the registering step includes receiving a registration confirmation that includes at least one of a user-id, a password, a login uniform resource locator (URL) and a universal resource identifier (URI).

4. The method of claim 2, wherein the download of the authoring application includes:
checking the client browser's version and downloading the DRM extension appropriate for the browser's version;
accessing an application to create SCO rights metadata and promotional material; and
generating a public key pair for the client for encryption purposes and sending a private key to the client,
wherein the accessing the application to create SCO rights metadata occurs through one of a web based remote access and a download the application.

5. The method of claim 1, wherein the assigning step includes:
logging on to a digital packager;
uploading a package containing the SCO and a metadata file; and
triggering a digital rights management (DRM) packager to assign digital rights to at least one of the SCO and the one or more assets and the package.

6. A method of claim, 5, wherein the triggering step includes assigning a price level to one of the SCO and the one or more assets controlled by the assigned digital rights.

7. The method of claim 5, further comprising the steps of:
parsing the package to extract structure and titles; and
assigning a package ID with a package name to the SCO.

8. The method of claim 1, further comprising:
generating promotional material and thumbnail for use in an electronic store (eStore) to provide searching and discovery capability; and
storing the promotional material and the SCO in an on-line catalog.

9. The method of claim 1, further comprising assigning digital rights to the one or more assets and encrypting at least one of the SCO and one or more assets.

10. The method of claim 1, wherein the assigning digital rights step assigns rights to the one or more assets to independently access the one or more assets under control of the assigned digital rights.

11. The method of claim 5, further comprising the step of placing the SCO, the metadata file and a promotional file into a digital container.

12. The method of claim 11, wherein the placing step includes at least one of assigning digital rights to the SCO and encrypting the one or more assets using randomly generated symmetric keys of the associated SCO.

13. The method of claim 12, wherein the digital rights include at least one of price, user identity, and length of use.

14. The method of claim 12, further including placing the randomly generated symmetric keys in the metadata file, and encrypting the metadata file with a public key.

15. The method of claim 1, wherein in the composing step the one or more assets include at least one of a video asset, a text asset, a music asset, and a learning asset.

16. A method of claim 1, further comprising packaging a content aggregation file separately from the SCO and any asset files, wherein the content aggregation file includes for the SCO: an associated metadata file, a manifest file, a content packaging information, and encrypted rights.

17. A method for creating learning objects, comprising:
creating a package containing one or more shareable content objects (SCOs);
assigning digital rights management (DRM) to the one or more SCOs;
updating an on-line electronic store (e-Store) with the one or more SCOs; and
making the one or more SCOs available for searching and downloading at a client,
wherein access to the one or more SCOs is controlled by the DRM, and the one or more SCOs include one or more assets individually controllable.

18. The method of claim 17, wherein in the creating a package step the package contains a content aggregation file containing at least one of a metadata, a manifest, content packaging information, and a encrypted rights for each SCO in the package.

19. The method of claim 17, further comprising the step of invoking a DRM packager to upload the package in compressed format and place in a digital container.

20. The method of claim 17, further comprising the step of storing the package in a learning objects repository for later retrieval by an on-line learning management system when the one or more SCOs is at least one of searched and accessed.

21. The method of claim 17, wherein:
the assigning DRM to the one or more SCOs include assigning a price to each of the one or more SCOs and at least one of the one or more assets, and the assigning the DRM step causes limitation of access to the one or more SCOs by user identity, price, or type of asset.

22. The method of claim 17, further comprising logging onto a portal server to perform any of the steps, wherein the portal server provides a common interface personalized to a user's profile and role.

23. The method of claim 17, further comprising: logging onto an electronic store (e-store) to access the one or more SCOs; and generating promotional material and supplying parameters indicating at least one of:
a package ID,
whether each of the SCOs is encrypted,
whether the one or more SCOs are to be delivered via on-line or off-line mode,
whether the package is a course or SCO,
a license server address,
content manager address,
and whether the promotional contents are packaged into a secure container.

24. The method of claim 17, further comprising assigning symmetric keys to each one or more SCOs and encrypting each one or more SCOs with the symmetric keys.

25. The method of claim 17, further comprising:
extracting information including thumbnail promotional material from a content aggregation(CA) file;
ingesting the one or more SCOs and CA file into a catalog using the information; and
storing the thumbnail promotional material into the catalog and associating the promotional material with the one or more SCOs,
wherein the thumbnail promotional material and one or more SCOs are searchable.

26. The method of claim 17, wherein the one or more assets are at least one of a video asset, a text asset, a music asset, and a learning asset.

27. A system for providing learning objects, comprising:
a portal server to permit authoring of at least one shareable content object (SCO) having one or more assets;
a digital rights management (DRM) content packager accessible via the portal server which assigns digital rights to the at least one shareable content object (SCO);
a DRM license server which assigns license criteria to the at least one SCO and the one or more assets; and
a content manager which stores or retrieves the at least one SCO and the one or more assets.

28. The system of claim 27, wherein the portal server provides a common interface personalized to a user's profile and role, and the portal server facilitates at least one of:
accessing a web base authoring application for creating the at least one SCO, and
downloading of an client authoring application for creating the at least one SCO.

29. The system of claim 27, wherein the DRM content packager communicates with the portal server for uploading the at least one SCO and communicates with a content manager loader for storing the at least one SCO in a learning objects repository and wherein the DRM content packager uploads a package and parses the package to extract structure and titles of the package, the package containing the at least one SCO and promotional material.

30. The system of claim 27, wherein the one or more assets is at least one of a video asset, a text asset, a music asset, and a learning asset.

31. The system of claim 27, wherein the at least one SCO is packaged into a digital container, and wherein the each of the at least one SCO and each of the one or more assets is associated with a price controlled by DRM.

32. A digital rights protection system, comprising:
a secure uploading service capable of receiving unprotected digital content having one or more parts, associated metadata, and one or more promotional materials;
an automatic validation component adapted to ensure conformance of the unprotected digital content to Shareable Content Object Reference Model (SCORM) standards and providing error messages to enable correction; and
a digital rights generation layer having one or more components adapted to provide a web-based interface for specifying different rights to the one or more parts for providing protected digital content.

33. The digital rights protection system of claim 32, further comprising a means for generating digital rights files and associating the digital rights files with the digital content by embedding links into a metadata right field within corresponding metadata files.

34. The digital rights protection system of claim 33, further comprising a transparent web service for automatically encrypting the protected digital content and the rights files, wherein the digital rights generation layer provides content protection services.

35. The digital rights protection system of claim 32, further comprising:
a security manager component adapted to provide secure communications with client stations and an electronic store; and
a content repository component which prevents any input/output operation that creates a rights violation when the protected digital content is stored.

36. The digital rights protection system of claim 32, further comprising a means for providing catalog creation services that includes invoking web services with a trusted electronic store to create a catalog entry of the protected digital content and any associated promotional material.

37. The digital rights protection system of claim 32, wherein all components of the rights generation layer has a public-key certificate by a certificate authority indicating that all the components are trusted.

38. The digital rights protection system of claim 32, wherein the digital rights generation layer provides updating and version control capabilities of the protected digital content and any associated metadata files.

39. A computer program product comprising a computer usable medium having readable program code embodied in the medium, the computer program product includes:
a first computer to compose a shareable content object (SCO) representing one or more assets;
a second computer code to assign a digital rights to the SCO to secure the one or more assets; and
a third computer code to individually access the SCO and the one or more assets, wherein the access to the SCO and the one or more assets is individually controlled by the assigned digital rights.
